(19) United States
(12) Patent Application Publication
(10) Pub. No.: US 2005/0194085 A1
(43) Pub. Date: Sep. 8, 2005

(54) Method for producing ceramic multilayer substrate

(75) Inventors: Takayoshi Oga, Saijo-shi (JP); Masao Konishi, Niihama-shi (JP); Masaki Ito, Oozu-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 11/069,016

(22) Filed: Feb. 28, 2005

(30) Foreign Application Priority Data
Mar. 2, 2004 (JP) 2004-057214

(51) Int. Cl. C03B 29/00

(52) U.S. Cl. 156/89.11; 156/89.12

(57) ABSTRACT

The present invention includes a first lamination step of laminating a green sheet on both sides of an alumina substrate sintered at a temperature higher than the sintering temperature of the green sheet to obtain a laminate; a second lamination step of laminating a green sheet for restraint that does not sinter at the sintering temperature of the green sheet on an outermost layer of the laminate to obtain a second laminate; a binder removal step of heating the second laminate at a first heating temperature in a range from 280° C. to 350° C. for a predetermined time to remove a binder component contained in the green sheet; a burning step of sintering the second laminate at a temperature in a range from 800° C. to 1000° C.; and a restraint layer removal step of removing the green sheet for restraint from the second laminate. By thus optimizing binder removal conditions, in a laminate of a burned alumina substrate and an unburned green sheet, the occurrence of delamination (layer separation) between the burned alumina substrate and the laminated ceramic green sheet is prevented even if materials having different coefficients of thermal expansion are stacked.

### BACKGROUND OF THE INVENTION

1. Field of the Invention

The present invention relates to a method for producing a ceramic multilayer substrate by laminating a pre-burning green sheet on a previously burned alumina substrate.

2. Description of the Related Art

Recently, a method for preparing a ceramic substrate with good dimensional accuracy with reduced burning shrinkage was proposed, in which an unburned ceramic green sheet is laminated on, and thermal-compression-bonded to, a burned alumina substrate, which then is burned to produce a ceramic multilayer substrate (JP2001-267743A). This production method is intended to suppress the burning shrinkage of the entire substrate by suppressing the burning shrinkage of the ceramic green sheet using the burned alumina substrate.

However, because the burning shrinkage force of the ceramic green sheet is great, the burning shrinkage of the ceramic green sheet cannot be suppressed fully even if an attempt is made to suppress the same using the burned alumina substrate only from one face of the ceramic green sheet. As a result, there may occur peeling between the burned layer of the ceramic green sheet and the burned alumina substrate, cracking in the burned layer of the ceramic green sheet, and warpage in the substrate, which in turn pose a problem of poor product yield.

To solve the problem, a production method was proposed in which an unburned ceramic green sheet is laminated on, and compression-bonded to, a burned alumina substrate to produce a laminate, and then a green sheet for restraint is laminated on, and compression-bonded to, both faces of this laminate, or lamination and compression bonding of an unburned ceramic green sheet and lamination and compression bonding of a green sheet for restraint are performed simultaneously, followed by restraint burning (pressure burning or non-pressure burning) (JP2003-258424A).

As shown in FIG. 4, one or a plurality of ceramic green sheets 2a, 2b are laminated on, and compression-bonded to, one or both faces of a burned alumina substrate 1 to produce a laminate, and thereafter green sheets 3a, 3b for restraint are laminated on, and compression-bonded to, both faces of this laminate, followed by burning the laminate.

In this operation, the unburned ceramic green sheet to be compression-bonded to the burned substrate in the laminate preparation step is formed so that the change in the thickness thereof upon compression bonding is equal to or more than the maximum difference in thickness due to irregularities of the burned substrate in order to prevent cracking of the burned substrate in the compression bonding step.

However, with the aforementioned conventional technique, it has been impossible to completely prevent the occurrence of delamination (layer separation) between the burned alumina substrate ant the laminated ceramic green sheet during lamination and burning of the burned alumina substrate and the unburned ceramic green sheet, and it has hence been impossible to produce a ceramic multilayer substrate with good quality at a high yield.

### SUMMARY OF THE INVENTION

In order to solve the problem described above, the present invention provides a method for producing a ceramic multilayer substrate with good quality at a high yield while preventing delamination during substrate burning.

The method for producing a ceramic multilayer substrate of the present invention includes a first lamination step of laminating a green sheet on both sides of an alumina substrate that has been sintered at a temperature higher than the sintering temperature of the green sheet to obtain a laminate, a second lamination step of laminating a green sheet for restraint that does not sinter at the aforementioned sintering temperature of the green sheet on the outermost layer of the laminate to obtain a second laminate, a binder removal step of heating the second laminate at a first heating temperature in the range from 280° C. to 350° C. for a predetermined time to remove the binder component contained in the green sheet, a burning step of sintering the second laminate at a temperature in the range from 800° C. to 1000° C., and a restraint layer removal step of removing the green sheet for restraint from the second laminate.

### BRIEF DESCRIPTION OF THE DRAWINGS

FIGS. 1A-1C are schematic cross-sectional views showing the step of ceramic multilayer substrate production in Example 1 of the present invention.

FIGS. 2A-2F are cross-sectional schematic diagrams showing the step of producing a ceramic multilayer substrate with cavities in Example 2 of the present invention.

FIG. 3A is a plan view of a module of a ceramic multilayer substrate with cavities of one example of the present invention, and FIG. 3B is a cross-sectional view of the same.

FIG. 4 is a schematic cross-sectional view of a conventional method for producing a ceramic multilayer substrate.

### DETAILED DESCRIPTION OF THE INVENTION

In the case of producing a ceramic multiplayer substrate, using a commercially available ceramic green sheet in which a binder component is made of acrylic resin (butyl acrylate.ethyl acrylate), and butyl benzyl phthalate (BBP) is added as a plasticizer (acrylic resin:BBP=about 7:3), usually, the temperature at a binder removal step is set at a high temperature (for example, 600° C.) that much exceeds the decomposition completion temperature of the binder component, and the binder component is completely removed from the green sheet. Here, the decomposition initiation temperature of the binder component refers to the temperature at which the binder component begins volatilizing from the green sheet upon external heating, and can be determined by detecting a change in the weight of the green sheet. The decomposition completion temperature of the binder component refers to the temperature at which the green sheet no longer shows a weight change. This decomposition completion temperature depends on the binder component, and is specifically about 370° C., and the binder removal temperature is about 500° C. to 600° C.

The present inventors attempted to solve the aforementioned problem by setting the temperature at a binder removal step at a temperature higher than conventional binder component decomposition completion temperatures, and changing other parameters, specifically conditions for green sheet lamination and conditions at a burning step. However, using any of these conditions, the problem remained unsolved. Hence, the inventors took note of the binder removal step, focusing on temperature settings for binder removal, and succeeded in solving the problem.

Accordingly, the present invention is a multilayer substrate production method that includes a first lamination step of laminating a green sheet on both sides of an alumina substrate sintered at a temperature higher than the sintering temperature of the green sheet to obtain a laminate, a second lamination step of laminating a green sheet for restraint that does not sinter at the aforementioned sintering temperature of the green sheet on the outermost layer of the laminate to obtain a second laminate, a binder removal step of heating the second laminate at a first heating temperature in the range from 280° C. to 350° C. for a predetermined time to remove the binder component contained in the green sheet, a burning step of sintering the second laminate at a temperature in the range from 800° C. to 1000° C., and a restraint layer removal step of removing the green sheet for restraint from the second laminate.

In the binder removal step, it is preferable to increase the temperature from room temperature to the first heating temperature, then maintain the first heating temperature for 2 hours to 6 hours, and thereafter decrease the temperature to room temperature. This is to ensure binder removal. The room temperature mentioned herein refers to a temperature in the range from 10° C. to 30° C.

It is preferable that the alumina substrate has an alumina content ratio of 90% by weight or higher.

It is preferable that the alumina substrate has been sintered at a temperature at least 100° C. higher than the sintering temperature of the green sheet.

It is preferable that the alumina substrate is provided with at least one member selected from the group consisting of a wiring pattern and a via conductor, which member is formed of a conductor paste composition.

It is preferable that the restraint layer removal is performed by removing the unsintered inorganic composition of the green sheet for restraint adhering to both faces of the burned substrate using at least one method selected from the group consisting of a water jet and ultrasonic cleaning.

The delamination prevention effect according to the present invention is considered to be obtained as follows.

When a conventional binder removal temperature is set to be equal to or higher than the decomposition completion temperature of a binder component, and the binder component is decomposed completely, the adhesion with respect to an alumina substrate is lost to cause delamination.

When the binder removal temperature is set to be lower than the decomposition completion temperature of the binder component, a part of the binder component remains in green sheets to maintain the adhesion between the green sheets, so that the delamination therebetween can be prevented.

### EXAMPLES

Hereinafter, the method for producing a ceramic multilayer substrate of the present invention will be described in detail by way of example with reference to the accompanying drawings.

### Examples 1 to 3 and Comparative Examples 1 to 4

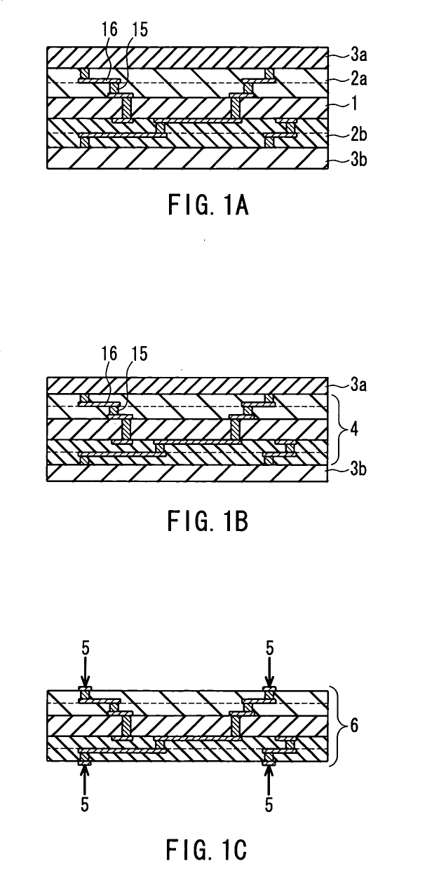

FIGS. 1A-1C are schematic cross-sectional views showing the process of producing a ceramic multilayer substrate of an example of the present invention.

On both faces of a burned alumina substrate 1 provided with a wiring pattern or a via conductor formed of a conductor paste composition or the like, one or a plurality of low-temperature-burning ceramic green sheets 2a, 2b were laminated. The ceramic green sheets were provided with a via conductor 15 formed by screen-printing a conductor paste composition on a punched or otherwise processed via. Likewise, by screen-printing a conductor paste composition, a wiring pattern 16 was also formed. Furthermore, on both faces of this laminate, green sheets for restraint 3a, 3b formed of an inorganic composition that does not sinter at the burning temperature of the ceramic green sheets were laminated (FIG. 1A).

Subsequently, a predetermined pressure was applied to the entire laminate to provide an integrated laminate (FIG. 1B).

After a binder removal step in which this integrated laminate was heated in air to remove the binder contained in the ceramic green sheets was performed, the laminate was transferred to a burning step of burning at a temperature of 900° C. During this operation, the ceramic green sheets sinter and bind firmly to the alumina substrate. At this time, the inorganic composition in the green sheet for restraint remained unsintered. After burning, the unsintered inorganic composition of the green sheet for restraint adhering to both faces of the burned substrate 4 was removed using a water jet and/or ultrasonic cleaning and a thick-layer conductor 5 was formed on both faces of the substrate, so that a non-shrinking ceramic multilayer substrate 6 was obtained (FIG. 1C).

Next, the samples in these examples are described. Laminates were prepared by laminating a green sheet of variable thickness on a burned alumina substrate of variable thickness with different alumina content ratios to produce 13 kinds of ceramic multilayer substrates. Their constitutions are shown in Table 1.

TABLE 1

| | Burned alumina | | | |
|---|---|---|---|---|
| | substrate | | Overall thickness of | |
| Sample | Aluminum content | Thickness | laminated green sheet | |
| number | ratio (wt %) | (μm) | 2a side (μm) | 2b side (μm) |
| 1 | 90 | 380 | 270 | 350 |
| 2 | 90 | 380 | 270 | 350 |
| 3 | 90 | 380 | 270 | 350 |
| 4 | 90 | 380 | 182 | 364 |
| 5 | 90 | 380 | 364 | 364 |
| 6 | 90 | 380 | 270 | 350 |
| 7 | 96 | 380 | 270 | 350 |
| 8 | 96 | 380 | 270 | 350 |
| 9 | 96 | 380 | 270 | 350 |
| 10 | 96 | 380 | 182 | 364 |
| 11 | 96 | 380 | 364 | 364 |
| 12 | 96 | 290 | 270 | 350 |
| 13 | 96 | 190 | 270 | 350 |

A burned alumina substrate and a green sheet that burns at a lower temperature than the alumina substrate have different coefficients of thermal expansion. Therefore, in a laminate of a burned alumina substrate and an unburned green sheet, like that of the present invention, time to maximum heating temperature (temperature increasing time), thermal stress due to maximum heating temperature, and thermal stress due to differential shrinkage during temperature fall are involved in the occurrence of delamination because materials of different coefficients of thermal expansion are stacked. For this reason, binder removal condition settings are important.

For the ceramic multilayer substrates of sample numbers 1 to 13, the binder removal conditions described in Examples 1 to 3 and Comparative Examples 1 to 4 were set, and the ceramic multilayer substrates were prepared according to the production method of FIGS. 1A-1C.

The maximum heating temperatures in Examples 1-3 were 280° C., 300° C., and 350° C., respectively. Regarding the temperature profile, the temperature was increased from room temperature to a maximum heating temperature over 4 hours, the maximum heating temperature was then maintained for 4 hours, and thereafter the temperature was decreased to room temperature (23° C.) over 4 hours.

The maximum heating temperature in Comparative Example 1 was 200° C.

Comparative Example 3 represents ordinary binder removal conditions. The maximum heating temperature in Comparative Examples 3 and 4 was 500° C. in both cases. Regarding the temperature profile of Comparative Example 1, the temperature was increased from room temperature to a maximum heating temperature over 8 hours, the maximum heating temperature was then maintained for 2 hours, and thereafter the temperature was decreased to room temperature over 8 hours. Regarding the temperature profile of Comparative Example 2, the temperature was increased from room temperature to a maximum heating temperature over 18 hours, the maximum heating temperature was then maintained for 2 hours, and thereafter the temperature was decreased to room temperature over 8 hours.

For these Examples and Comparative Examples, samples were evaluated for delamination (layer separation), cracking and substrate warpage. The evaluations were based on visual observations using a microscope.

In Table 2, A indicates the rating “good” (no delamination/cracking/warpage etc.), B “partially delaminated”, X “generally delaminated”, and XX “both cracking and warpage”.

The results are shown in Table 2.

TABLE 2

| | | Com. | | | | Com. | Com. | Com. |
|---|---|---|---|---|---|---|---|---|
| | | Ex. 1 | Ex. 1 | Ex. 2 | Ex. 3 | Ex. 2 | Ex. 3 | Ex. 4 |
| | Burned | 200° C.⁽¹⁾ | 280° C. | 300° C. | 350° C. | 400° C. | 500° C. | 500° C. |
| Sample | alumina | 4 Hr⁽²⁾ | 4 Hr | 4 Hr | 4 Hr | 4 Hr | 2 Hr | 2 Hr |
| number | substrate | 12 Hr⁽³⁾ | 12 Hr | 12 Hr | 12 Hr | 12 Hr | 18 Hr | 28 Hr |
| 1 | Alumina | XX | A | A | A | B | X | X |
| 2 | content | XX | A | A | A | B | X | X |
| 3 | ratio | XX | A | A | A | B | X | X |
| 4 | 90 wt % | XX | A | A | A | B | X | X |
| 5 | | XX | A | A | A | B | X | X |
| 6 | | XX | A | A | A | B | X | X |
| 7 | Alumina | XX | A | A | A | B | X | X |
| 8 | content | XX | A | A | A | B | X | X |
| 9 | ratio | XX | A | A | A | B | X | X |
| 10 | 96 wt % | XX | A | A | A | B | X | X |
| 11 | | XX | A | A | A | B | X | X |
| 12 | | XX | A | A | A | B | X | X |
| 13 | | XX | A | A | A | B | X | X |

Remarks:
⁽¹⁾Maximum heating temperature
⁽²⁾Maximum heating temperature retention time
⁽³⁾Total treatment time

As shown in Table 2, in Comparative Example 3, which employed conventional binder removal conditions, delamination occurred in all the samples. Even when the temperature was increased slowly over a time more than doubling the ordinary temperature rising time, as in Comparative Example 4, delamination occurred in all samples.

If the binder removal treatment of the green sheet is insufficient, the binder component remains inside the green sheet, and the substrate after burning suffers cracking or warpage as it expands upon volatilization of the binder component due to the burning heat in the subsequent burning step. As a result, it is impossible to obtain a substrate with good quality.

In Comparative Example 1, since the binder removal is performed at a temperature lower than usual, the maximum heating temperature retention time was doubled, compared to the ordinary level, to 4 hours. However, binder removal was insufficient, and cracking or warpage occurred in all the samples.

As shown in Examples 1 to 3, when the maximum heating temperature was 280 to 350° C., no delamination was observed in any sample. Nor was there any substrate cracking or warpage. Therefore, the maximum heating temperature of a laminate of a burned alumina substrate and a green sheet having a burning temperature lower than the burning temperature of the alumina substrate, like the present invention, desirably is 280 to 350° C.

In Comparative Example 2, in which the maximum heating temperature was 400° C., thermal stress appeared and slight delamination was observed in some samples.

### Example 4

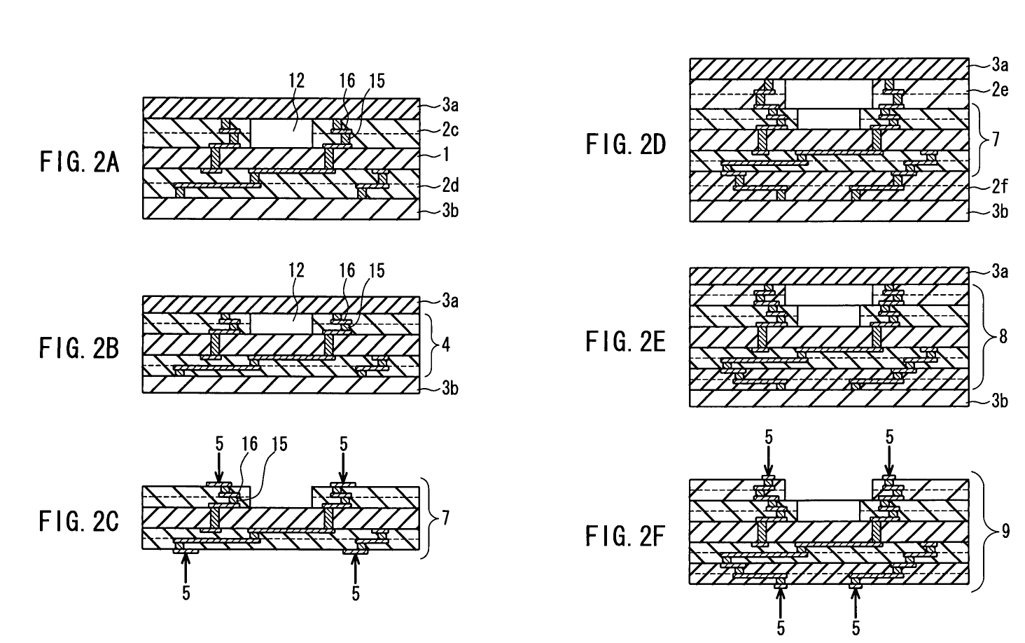

The production method of the present invention is also applicable to ceramic multilayer substrates with cavities. A cavity opening may be formed in a ceramic green sheet before lamination using a punching step or the like. FIGS. 2A-2F are schematic cross-sectional views showing the method for producing a ceramic multilayer substrate with cavities of this example.

On both faces of a burned alumina substrate 1 provided with a wiring pattern and a via conductor, both formed of a conductor paste composition or the like, one or a plurality of low-temperature-burning ceramic green sheets 2c, 2d were laminated. Each ceramic green sheet was provided with a via conductor 15 formed by screen-printing a conductor paste composition on a punched or otherwise processed via, and also provided with a wiring pattern 16 likewise formed by screen-printing a conductor paste composition. Also, the sheet 2c was provided with a cavity opening 12 formed by a punching step. Furthermore, on both faces of this laminate, green sheets for restraint 3a, 3b formed of an inorganic composition that does not sinter at the burning temperature of the ceramic green sheets were laminated (FIG. 2A).

This laminate was compressed with a press to obtain an integrated laminate (FIG. 2B).

The laminate was removed and heated in air in a binder removal step, and then it was burned at a peak temperature of 900° C. In this operation, the ceramic green sheets were sintered, whereas the inorganic composition in the green sheet for restraint remained unsintered. After burning, the unsintered inorganic composition of the green sheet for restraint adhering to both faces of the burned substrate 4 was removed using a water jet and/or ultrasonic cleaning. Furthermore, a thick-layer conductor 5 was formed on both faces of the substrate, and thus a burned laminate 7 was obtained (FIG. 2C).

Furthermore, on both sides of the burned laminate 7, one or a plurality of low-temperature-burning ceramic green sheets 2e, 2f were laminated. Each ceramic green sheet was provided with a via conductor formed by screen-printing a conductor paste composition on a punched or otherwise processed via, and also provided with a wiring pattern likewise formed by screen-printing a conductor paste composition. Also, 2e was provided with a cavity opening formed by a punching step. Furthermore, on both faces of this laminate, green sheets for restraint 3a, 3b formed of an inorganic composition that do not sinter at the burning temperature of the ceramic green sheets were laminated (FIG. 2D).

This laminate was compressed using a press to obtain an integrated laminate (FIG. 2E).

The laminate was removed and heated in air in a binder removal step, and then it was burned at a peak temperature of 900° C. In this operation, the ceramic green sheets were sintered, whereas the inorganic composition in the green sheet for restraint remained unsintered. After burning, the unsintered inorganic composition of the green sheet for restraint adhering to both faces of the burned substrate 8 was removed using a water jet and/or ultrasonic cleaning. Furthermore, a thick-layer conductor 5 was formed on both faces of the substrate, and thus a ceramic multilayer substrate 9 with two stage cavities was obtained (FIG. 2F).

Because the aluminum content ratio of the burned alumina substrate is as high as 90 wt % or higher, the heat release effect is high. For this reason, the module of the ceramic multilayer substrate with cavities obtained in FIG. 2F is capable of efficiently releasing the heat generated from components such as a semiconductor device (IC) as it has the alumina substrate inside thereof.

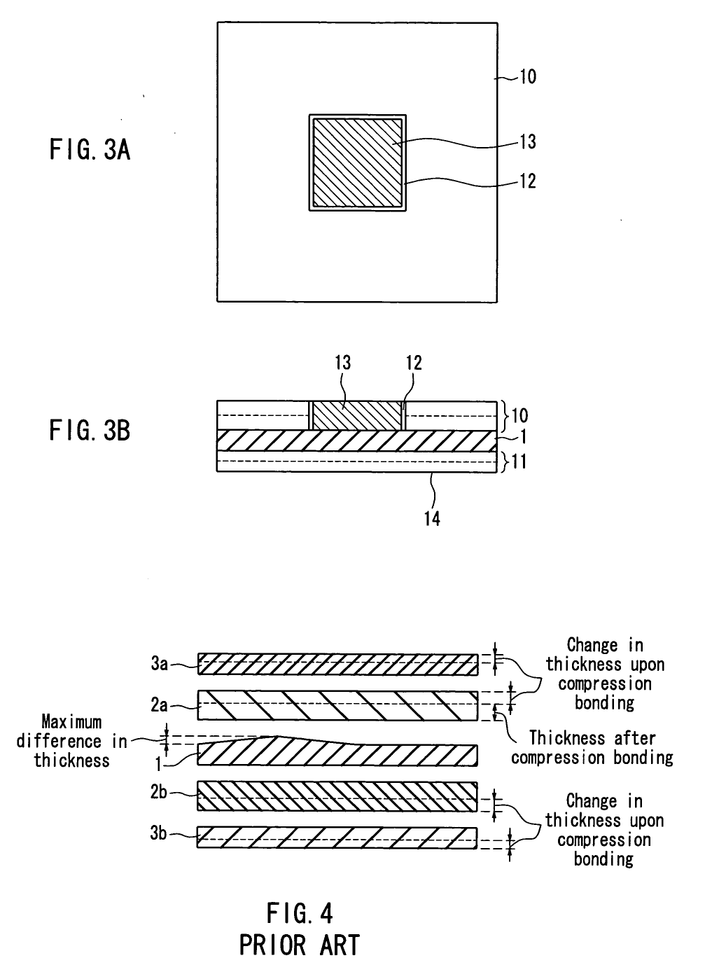

FIG. 3 shows an appearance of the module. The module measured 6.2 mm in length and 6.2 mm in width, the cavity opening measured 2.0 mm in length and 2.0 mm in width, the cavity portion 10 measured 0.3 mm in thickness, and the non-cavity portion ceramic 11 measured 0.2 mm in thickness. An IC 13 is mounted in the cavity opening 12, the thermal resistance of a face 14 opposite to the face on which the IC was mounted was determined, and the results are shown Table 3. Sample number 1 did not employ an alumina substrate for the IC mounting substrate 1, but did employ a low-temperature-burning ceramic green sheet material with a thickness of 380 μm (the same material as for 10 and 11). Sample number 2 employed an alumina substrate with a thickness of 190 μm (alumina substrate 1) for the IC mounting substrate 1. Sample number 3 employed an alumina substrate with a thickness of 380 μm (alumina substrate 2) for the IC mounting substrate 1.

TABLE 3

| | | Thermal resistance |
|---|---|---|
| Sample | IC mounting | measurement |
| number | substrate | result (° C./W) |
| 1 | Low-temperature- | 329.7 |
| | burning ceramic | |
| 2 | Alumina substrate 1 | 80.3 |
| 3 | Alumina substrate 2 | 52.2 |

As shown in Table 3, the ceramic multilayer substrate modules employing an alumina substrate (sample numbers 2 and 3) had remarkably improved heat release performance compared to the ceramic multilayer substrate module constituted with the low-temperature-burning ceramic material alone (sample number 1).

The method for producing a ceramic multilayer substrate of the present invention is useful in producing a high-density wiring substrate with high quality that does not suffer interlayer delamination, cracking and warpage during preparation of a stacked assembly by laminating and burning materials having different coefficients of thermal expansion. The same method makes it possible to provide a high-density wiring substrate having remarkably improved heat release performance using an alumina substrate having an aluminum content ratio of 90% or higher.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A method for producing a ceramic multilayer substrate comprising:
a first lamination step of laminating a green sheet on both sides of an alumina substrate sintered at a temperature higher than the sintering temperature of the green sheet to obtain a laminate;
a second lamination step of laminating a green sheet for restraint that does not sinter at the sintering temperature of the green sheet on an outermost layer of the laminate to obtain a second laminate;
a binder removal step of heating the second laminate at a first heating temperature in a range from 280° C. to 350° C. for a predetermined time to remove a binder component contained in the green sheet;
a burning step of sintering the second laminate at a temperature in a range from 800° C. to 1000° C.; and
a restraint layer removal step of removing the green sheet for restraint from the second laminate.

2. The method for producing a ceramic multilayer substrate according to claim 1, wherein in the binder removal step, the temperature is increased from room temperature to the first heating temperature, the first heating temperature is then maintained for a time in a range from 2 hours to 6 hours, and thereafter the temperature is decreased to room temperature.

3. The method for producing a ceramic multilayer substrate according to claim 1, wherein the alumina substrate has an alumina content ratio of 90% by weight or higher.

4. The method for producing a ceramic multilayer substrate according to claim 1, wherein the alumina substrate has been sintered at a temperature at least 100° C. higher than the sintering temperature of the green sheet.

5. The method for producing a ceramic multilayer substrate according to claim 1, wherein the alumina substrate is provided with at least one member selected from the group consisting of a wiring pattern and a via conductor, which member is formed of a conductor paste composition.

6. The method for producing a ceramic multilayer substrate according to claim 1, wherein the restraint layer removal is performed by removing an unsintered inorganic composition of the green sheet for restraint adhering to both faces of the burned substrate using at least one selected from the group consisting of a water jet and ultrasonic cleaning.

7. The method for producing a ceramic multilayer substrate according to claim 1, wherein the green sheet layer is provided with a cavity opening.

8. The method for producing a ceramic multilayer substrate according to claim 1, wherein a semiconductor device is mounted in the cavity opening.
